(19) United States
(12) Patent Application Publication
(10) Pub. No.: US 2023/0297627 A1
(43) Pub. Date: Sep. 21, 2023

(54) SYSTEM AND METHODS FOR MONITORING AND VALIDATING SCIENTIFIC RESEARCH SOURCES

(71) Applicant: Frederick James Meyler, Oakland, CA (US)

(72) Inventor: Frederick James Meyler, Oakland, CA (US)

(21) Appl. No.: 18/020,254

(22) PCT Filed: Aug. 5, 2021
(86) PCT No.: PCT/US2021/044849

§ 371 Date: Feb. 7, 2023

Related U.S. Application Data
(60) Provisional application No. 63/062,912, filed on Aug. 7, 2020.

(51) Int. Cl. G06F 16/908

(52) U.S. Cl. CPC G06F 16/908

(57) ABSTRACT

A source validation system and associated methods are disclosed for automatically monitoring and validating the integrity of an at least one primary article on behalf of a user. In at least one embodiment, a computing device is configured for receiving and processing data related to the at least one primary article and at least one of an at least one associated primary source, secondary source and tertiary source. An at least one article record is associated with each of the at least one primary article, with each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article. The article score represents a standardized, relative and absolute score denoting quality and reliability of said primary article, such that the lower the article score, the relatively more reliable said primary article is determined to be.

### RELATED APPLICATIONS

This application claims priority and is entitled to the filing date of U.S. Provisional Application Serial No. 63/062,912, filed on Aug. 7, 2020. The contents of the aforementioned application are incorporated herein by reference.

### BACKGROUND

The subject of this patent application relates generally to scientific research, and more particularly to a system and associated methods for automatically monitoring and validating the integrity of scientific research sources.

Applicant hereby incorporates herein by reference any and all patents and published patent applications cited or referred to in this application.

By way of background, all Western science since the days of Hooke, Boyle, and Newton has gone through a peer review process, and no scientific discovery has taken place without being published in a peer reviewed journal since. Scientists traditionally look at the articles in their field, conduct research based on them, and compile the results in the form of their own article. They submit those articles for publication, and the publisher validates their research by having a qualified scientist in the field review the work, usually as a single or double blind process to ensure lack of bias. This review is then passed on to the editor, who rejects or approves the work; and if approved, it is published and joins the current body of scientific work as a further source that may be subsequently relied upon by others. If a source lacks scientific integrity, it is rejected through public rebuttal and the results of repeating the experiment, and it will be retracted by the publisher. A given source could be deemed “bad” due to a number of different reasons, such as for being expressly retracted by the publisher, or for containing out-of-date information, or for being associated with a disreputable publisher or author, or simply for lacking relevance. The number of retractions have increased over ten times in the past decade, even when accounting for the overall increase in articles per year. Retracting mistakes is a good thing, as the increase illustrates that the scientific community is attempting to correct problems; however, those retractions are only helpful if researchers are able to readily identify any such retractions that relate to their current work. If not readily identified by researchers, bad sources have the potential of wasting time and money, tarnishing or destroying careers, and even causing loss of life or leaving certain illnesses uncured.

Accordingly, there remains a need for a system and associated methods for automatically monitoring and validating the integrity of scientific research sources. Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a source validation system and associated methods for automatically monitoring and validating the integrity of primary article on behalf of a user, in accordance with at least one embodiment. In at least one embodiment, a computing device is configured for receiving and processing data related to the at least one primary article and at least one of an at least one associated primary source, secondary source and tertiary source. An at least one article record is associated with each of the at least one primary article, with each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article. Upon the user desiring to validate the integrity of a one of the at least one primary article via the computing device, the computing device accesses the retraction table of the associated article record for said primary article. Upon the computing device determining that said primary article has been retracted, the computing device adds a pre-defined numerical primary article weight to the article score for said primary article. The computing device determines a primary source total count, representing a quantity of primary sources associated with said primary article, and a primary source retraction count, representing a quantity of said primary sources associated with said primary article that have been retracted, and generates a primary source ratio by calculating a quotient of the primary source retraction count divided by the primary source total count. The computing device multiplies the primary source ratio by a pre-defined numerical primary source weight that is relatively less than the primary article weight, and adds the product of said calculation to the article score. The computing device determines a secondary source total count, representing a quantity of secondary sources associated with said primary article, and a secondary source retraction count, representing a quantity of said secondary sources associated with said primary article that have been retracted, and generates a secondary source ratio by calculating a quotient of the secondary source retraction count divided by the secondary source total count. The computing device multiplies the secondary source ratio by a pre-defined numerical secondary source weight that is relatively less than the primary source weight, and adds the product of said calculation to the article score. The computing device determines a tertiary source total count, representing a quantity of tertiary sources associated with said primary article, and a tertiary source retraction count, representing a quantity of said tertiary sources associated with said primary article that have been retracted, and generates a tertiary source ratio by calculating a quotient of the tertiary source retraction count divided by the tertiary source total count. The computing device multiplies the tertiary source ratio by a pre-defined numerical tertiary source weight that is relatively less than the secondary source weight, and adds the product of said calculation to the article score. Accordingly, in such embodiments, the article score represents a standardized, relative and absolute score denoting quality and reliability of said primary article, such that the lower the article score, the relatively more reliable said primary article is determined to be.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary source validation system, in accordance with at least one embodiment;

FIG. 2 is an architecture diagram of an exemplary article record, in accordance with at least one embodiment;

FIG. 3 is a diagram of an exemplary primary article and associated primary sources, secondary sources and tertiary sources, in accordance with at least one embodiment;

FIG. 4 is a flow diagram of an exemplary method of dynamically calculating an article score for a given primary article; and

FIG. 5 is an illustration an exemplary user interface as displayed by an exemplary user device, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

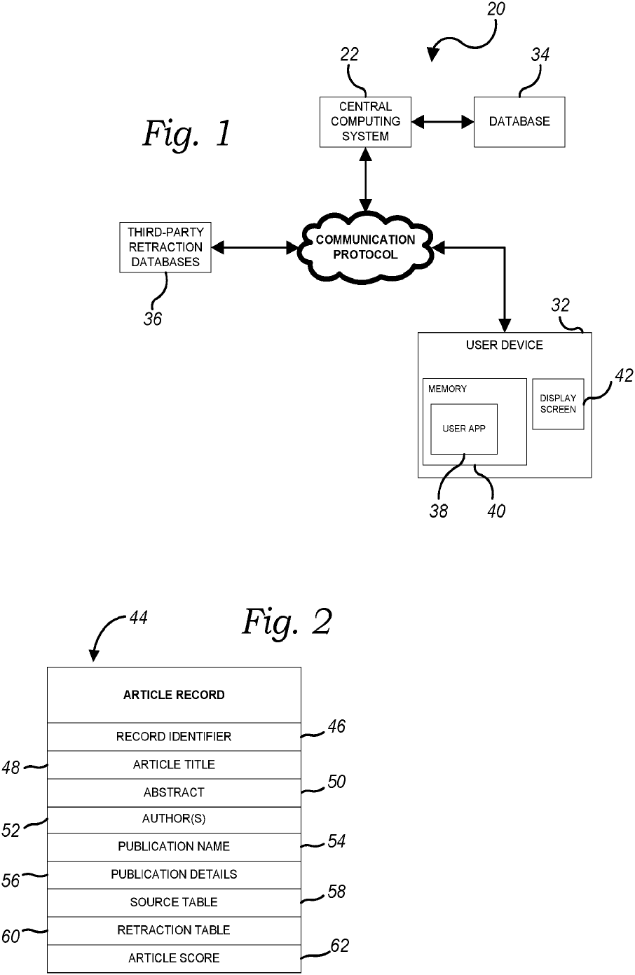

Turning now to FIG. 1, there is shown a simplified schematic view of an exemplary source validation system 20 configured for automatically monitoring and validating the integrity of scientific research sources, in accordance with at least one embodiment. At the outset, it should be noted that the term “article” as used herein is intended to mean a published article from a peer reviewed academic journal or publication; the term “primary article” as used herein is intended to mean an article that is being reviewed by a researcher (i.e., a user of the system 20) to validate the sources cited by the article; the term “primary source” as used herein is intended to mean an article that is cited as a source by the primary article; the term “secondary source” as used herein is intended to mean an article that is cited as a source by a primary source; the term “tertiary source” as used herein is intended to mean an article that is cited as a source by a secondary source; the term “peer article” as used herein is intended to mean an article, other than the primary article, that has also cited a primary source; the term “peer source” as used herein is intended to mean an article that is cited as a source by a peer article; and the term “retraction” as used herein is intended to mean an article that has been flagged or otherwise identified as unsuitable for use for one or more reasons.

With continued reference to FIG. 1, in at least one embodiment, the system 20 provides a central computing system 22 configured for receiving and processing data related to an at least one primary article 24 and at least one of an at least one associated primary source 26, secondary source 28 and tertiary source 30. An at least one user device 32 is in selective communication with the computing system 22, as discussed further below. Additionally, in at least one embodiment, an at least one database 34 34 is in communication with the computing system 22 and configured for selectively storing said data related to each of the at least one primary article, primary source, secondary source and tertiary source. In at least one embodiment, the computing system 22 and database 34 are one and the same – as such, it is intended that those terms as used herein are to be interchangeable with one another. In at least one embodiment, the computing system 22 and database 34 are omitted, such that the system 20 and associated methods described herein are implemented solely through the at least one user device 32 - thus, any methods or functionality described herein as being carried out by the computing system 22 or database 34 may, in at least one embodiment, also be carried out by the at least one user device 32, regardless of whether such embodiments nevertheless incorporate the computing system 22 and/or database 34. In at least one embodiment, the computing system 22 is also in selective communication with an at least one third-party retraction database 36 containing retraction-related data in connection with at least one of the primary article 24, primary sources 26, secondary sources 28 and tertiary sources 30, as discussed further below.

At the outset, it should be noted that communication between each of the computing system 22, at least one user device 32, at least one database 34, and at least one third-party retraction database 36 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. Similarly, in at least one embodiment, communications between each of the computing system 22, at least one user device 32, and at least one database 34 may be encrypted using any encryption method (or combination of methods) now known or later developed. It should also be noted that the term “user device 32” is intended to include any type of computing or electronic device, now known or later developed, capable of communicating with the computing system 22 and carrying out the functionality described herein - such as desktop computers, browser extensions, mobile phones, smartphones, laptop computers, tablet computers, personal data assistants, gaming devices, wearable devices, etc. As such, the present invention should not be read as being limited to use with any one particular type of computing or electronic device, even though certain exemplary devices may be mentioned or shown herein for illustrative purposes.

With continued reference to FIG. 1, in the exemplary embodiment, each of the computing system 22, at least one user device 32, and at least one database 34 contains the hardware and software necessary to carry out the exemplary methods for administering the source validation system 20, as described herein. Furthermore, in at least one embodiment, the computing system 22 comprises a plurality of computing devices selectively working in concert with one another to carry out the exemplary methods for administering the source validation system 20, as described herein. In at least one embodiment, the at least one user device 32 provides a user application 38 residing locally in memory 40 on the user device 32 (either as a standalone application or as a browser extension for an existing Internet browser on the user device 32), the user application 38 being configured for selectively communicating with the computing system 22, as discussed further below. It should be noted that the term “memory” is intended to include any type of electronic storage medium (or combination of storage mediums) now known or later developed, such as local hard drives, RAM, flash memory, secure digital (“SD”) cards, external storage devices, network or cloud storage devices, integrated circuits, etc. Additionally, in at least one embodiment, each of the at least one user device 32 is in the possession of a user who is desirous of utilizing the system 20 to automatically monitor and validate the integrity of scientific research sources.

Furthermore, the various components of the at least one user device 32 may reside on a single computing and/or electronic device, or may separately reside on two or more computing and/or electronic devices in communication with one another. In at least one alternate embodiment, the functionality provided by the user application 38 resides remotely in memory on the computing system 22 and/or database 34, with the at least one user device 32 capable of accessing said functionality via an online portal hosted by (or at least in communication with) the computing system 22 and/or database 34, either in addition to or in lieu of the user application 38 residing locally in memory 40 on the at least one user device 32. It should be noted that, for simplicity purposes, the functionality provided by the user application 38 will be described herein as such – even though certain embodiments may provide said functionality through an online portal. It should also be noted that, for simplicity purposes, when discussing functionality and the various methods that may be carried out by the system 20 herein, the terms “user device 32” and “user application 38” are intended to be interchangeable. With continued reference to FIG. 1, in at least one embodiment, the at least one user device 32 provides an at least one display screen 42 for providing an at least one graphical user interface to assist the associated user in possession of said user device 32 to access and utilize the various functions provided by the system 20.

In at least one embodiment, as illustrated in the architecture diagram of FIG. 2, the computing system 22 – or the at least one database 34 – stores and manages an article record 44 for each primary article 24 containing various details related to the primary article 24 and each of the associated primary sources 26, secondary sources 28 and tertiary sources 30. In at least one embodiment, each article record 44 contains at least one of a unique record identifier 46, an article title 48 associated with the primary article 24, an abstract 50 associated with the primary article 24, an at least one author 52 associated with the primary article 24, a publication name 54 in which the primary article 24 was published, additional publication details 56 associated with the primary article 24 (e.g., issue number, year of publication, URL to full primary article 24, etc.), a source table 58 containing details related to each of the associated primary sources 26, secondary sources 28 and tertiary sources 30 as discussed further below, a retraction table 60 containing details related to any instances in which the primary article 24 has been retracted (including the reasons for retraction), and an article score 62 containing a numerical value corresponding to the relative validity of the primary article 24 as dynamically calculated by the system 20 and discussed further below. In at least one embodiment, each entry in the source table 58 links to an article record 44 associated with a given one of the associated primary sources 26, secondary sources 28 and tertiary sources 30, such that the system 20 maintains the same type of data for each of the associated primary sources 26, secondary sources 28 and tertiary sources 30 as it does for the primary article 24. It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited.

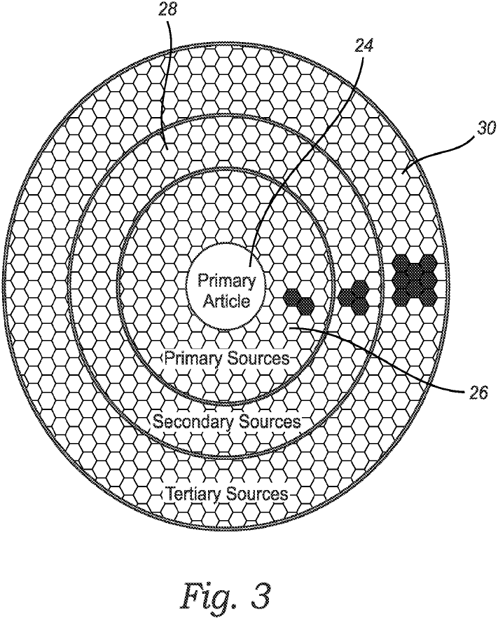

As mentioned above, in at least one embodiment, the article score 62 for a given primary article 24 is a numerical value that is dynamically calculated by the computing system 22 so as to derive a quality rating of the primary article 24 based on the quality of the associated primary sources 26, secondary sources 28 and tertiary sources 30. In other words, in at least one such embodiment, the article score 62 is similar to a credit score in that it provides a standardized, relative and absolute score in points for a given primary article 24, which the user may then rely upon before deciding whether to cite the primary article 24 in their own research. In a bit more detail, in at least one embodiment, the computing system 22 derives the article score 62 for a given primary article 24 by analyzing each of the associated primary sources 26, secondary sources 28 and tertiary sources 30 for unique retractions (i.e., a retraction for a given source 26, 28 or 30 is only counted once per generation). As illustrated in the diagram of FIG. 3 (wherein each hexagon represents a discrete source 26, 28 or 30, with the solid hexagons representing sources 26, 28 or 30 that have been retracted), the further down in the primary article’s 24 genealogy the retraction appears, the less it negatively affects the article score 62. In other words, a tertiary source 30 having a retraction won’t reduce the article score 62 as much as a secondary source 28 having a retraction. Likewise, in at least on embodiment, if the same retracted article is both a primary source 26 and a secondary source 28 for a given primary article 24, the system 20 counts the retraction twice when calculating the article score 62.

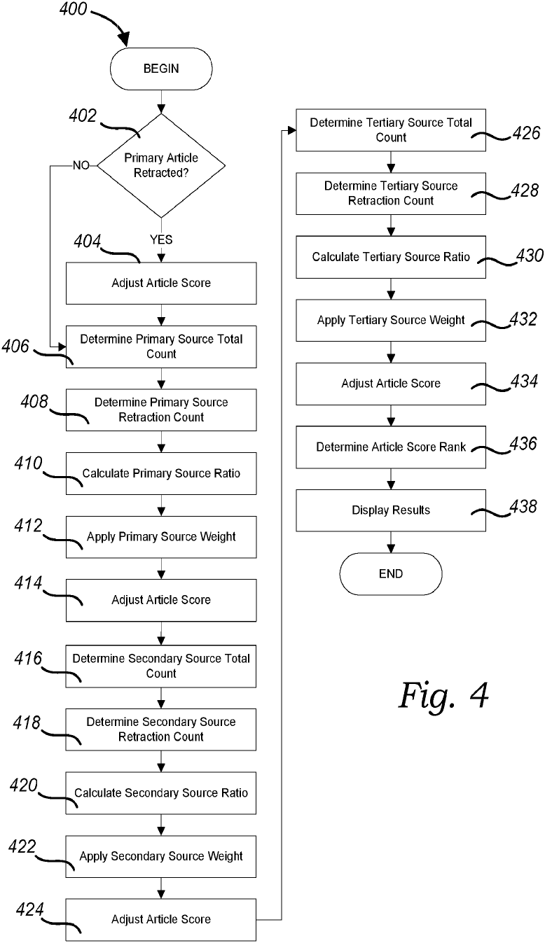

In at least one embodiment, as illustrated in the flow diagram of FIG. 4, through the user application 38 residing either locally in memory 40 on the at least one user device 32 or remotely on the computing system 22 and/or database 34, the method of dynamically calculating the article score 62 for a given primary article 24 entails the steps of the computing system 22 first determining whether the primary article 24 itself has been retracted (402). If the primary article 24 itself has been retracted, the computing system 22 adds a relatively large numerical primary article weight to the article score 62 (404) – significantly larger than the possible numerical weights that could be attributed to any of the primary sources 26, secondary sources 28 and tertiary sources 30, such as 1,000,000 for example. With reference again to the diagram of FIG. 3, the computing system 22 next determines a primary source total count representing the quantity of primary sources 26 associated with the primary article 24 (406), and further determines a primary source retraction count representing the quantity of said primary sources 26 that have been retracted (408). From there, the computing system 22 determines a primary source ratio by calculating the quotient of the primary source retraction count divided by the primary source total count (410), and then multiplies the primary source ratio by a numerical primary source weight that is relatively less than the primary article weight (412) – such as 10,000 for example – with the product of that calculation being added to the article score 62 (414). The computing system 22 next determines a secondary source total count representing the quantity of secondary sources 28 associated with the primary article 24 (416), and further determines a secondary source retraction count representing the quantity of said secondary sources 28 that have been retracted (418). From there, the computing system 22 determines a secondary source ratio by calculating the quotient of the secondary source retraction count divided by the secondary source total count (420), and then multiplies the secondary source ratio by a numerical secondary source weight that is relatively less than the primary source weight (422) – such as 100 for example – with the product of that calculation being added to the article score 62 (424). The computing system 22 next determines a tertiary source total count representing the quantity of tertiary sources 30 associated with the primary article 24 (426), and further determines a tertiary source retraction count representing the quantity of said tertiary sources 30 that have been retracted (428). From there, the computing system 22 determines a tertiary source ratio by calculating the quotient of the tertiary source retraction count divided by the tertiary source total count (430), and then multiplies the tertiary source ratio by a numerical tertiary source weight that is relatively less than the secondary source weight (432) – such as 1 for example – with the product of that calculation being added to the article score 62 (434). It should be noted that the above-mentioned weight amounts are merely exemplary and intended to simply illustrate the exemplary method described herein. In further embodiments, other weight amounts may be utilized, so long as the primary source weight is relatively less than the primary article weight, the secondary source weight is relatively less than the primary source weight, and the tertiary source weight is relatively less than the secondary source weight. It should also be noted that retraction-related data associated with any of the primary article 24, primary sources 26, secondary sources 28 and tertiary sources 30 may be automatically obtained by the computing system 22 from one or more of the database 34 and third-party retraction databases 36 (such as Cabell’s, PubMed, etc.).

Using the exemplary primary article 24 illustrated in the diagram of FIG. 3, where the primary article 24 has not been retracted, the primary source total count is 120, the primary source retraction count is 2, the primary source weight is 10,000, the secondary source total count is 168, the secondary source retraction count is 3, the secondary source weight is 100, the tertiary source total count is 345, the tertiary source retraction count is 8, and the tertiary source weight is 1, the calculated article score 62 in such an exemplary scenario would be 168.476. In such embodiments, the lower the article score 62, the better the quality of the primary article 24.

In at least one embodiment, the computing system 22 further modifies (i.e., increases) the article score 62 upon determining that the publication(s) 54 in which any of the primary article 24, primary sources 26, secondary sources 28, or tertiary sources 30 was published have been identified as being predatory – i.e., publications that utilize an exploitive academic publishing business model that involves charging publication fees to authors without checking articles for quality and legitimacy and without providing the other editorial and publishing services that legitimate academic publications provide – using the same relative weighting technique described above for each of the primary article 24, primary sources 26, secondary sources 28, and tertiary sources 30. In at least one embodiment, the computing system 22 further modifies (i.e., increases) the article score 62 upon determining that the author(s) 52 associated with any of the primary article 24, primary sources 26, secondary sources 28, or tertiary sources 30 have engaged in self-citing over a predetermined threshold quantity, using the same relative weighting technique described above for each of the primary article 24, primary sources 26, secondary sources 28, and tertiary sources 30. In at least one embodiment, the computing system 22 further modifies (i.e., increases) the article score 62 upon determining that the publication(s) 54 in which any of the primary article 24, primary sources 26, secondary sources 28, or tertiary sources 30 was published have been identified as failing to issue any retractions, using the same relative weighting technique described above for each of the primary article 24, primary sources 26, secondary sources 28, and tertiary sources 30.

In at least one embodiment, the computing system 22 performs the same steps to calculate an article score 62 for one or more peer articles in order to establish a baseline for comparison purposes. Thus, with continued reference to FIG. 4, in at least one embodiment, upon the computing system 22 calculating the article score 62, the computing system 22 compares the article score 62 of the primary article 24 against the article score 62 of one or more peer articles (436) in order to determine a relative rank for the article score 62 of the primary article 24 (i.e., to determine the relative quality of the primary article 24). In at least one embodiment, the computing system 22 compares the article score 62 of the primary article 24 against an average article score 62 of all peer articles associated with a given publication 54 during a given time period in order to determine a relative rank for the article score 62 of the primary article 24.

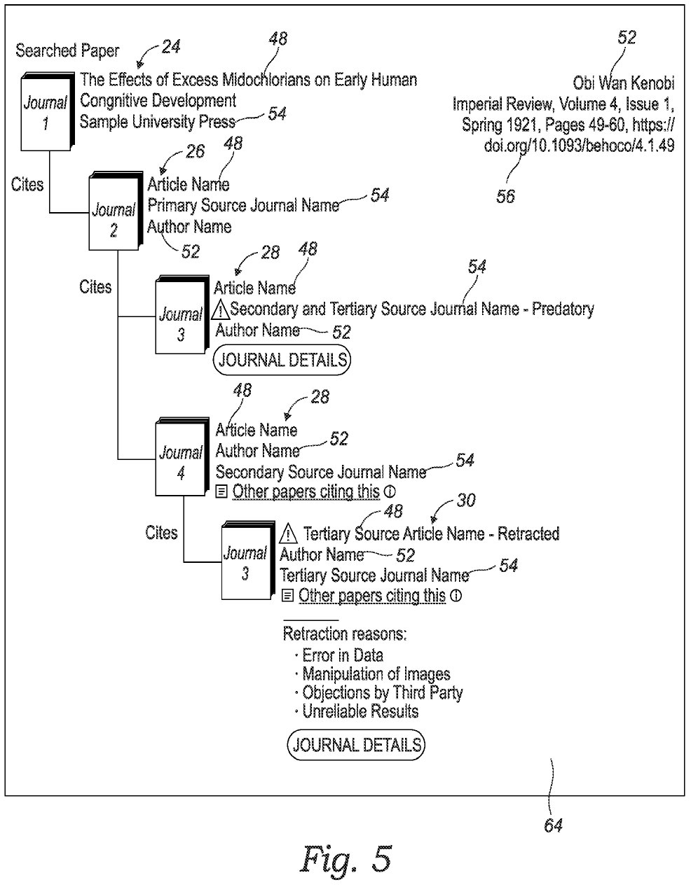

In at least one embodiment, these details are then provided to the user via a user interface 64 as displayed on the user device 32 (438), including clickable links that provide further information to the user, such as details as to why a given retraction was issued. An illustration of an exemplary such user interface 64 is shown in FIG. 5.

In at least one embodiment, the computing system 22 allows the user to specify one or more user-defined criteria upon which the computing system 22 calculates the article score 62 for a given primary article 24. Such user-defined criteria may then be saved by the user as a schema so as to share that schema with other users as desired. In at least one such embodiment, the computing system 22 creates a schema profile for each publication 54, so that authors will know the parameters upon which the publication 54 has historically published. Any citations that deviate from the median are identified, along with the ratio of articles the publication 54 has published that deviate more than the primary article 24 in that particular aspect (or aspects) of the schema. This allows users to save hours and hours of reading, filtering out results that are outside of their acceptable range based on their search schema, and floating the best matches to the top. This also allows publications 54 to better determine which article they approve for publishing, and to generate historic trending reports of themselves and their competition based on the schema components. Thus, the system 20 better ensures that researchers don’t spend money on a bad research project, authors don’t get rejected because of bad sources when they submit for publication, and publishers don’t tarnish their standing in the field by letting bad science get published under their name.

Aspects of the present specification may also be described as follows:

1. A method for monitoring and validating the integrity of an at least one primary article on behalf of a user, the method comprising the steps of: implementing a computing device configured for receiving and processing data related to the at least one primary article and at least one of an at least one associated primary source, secondary source and tertiary source; establishing, via the computing device, an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and upon the user desiring to validate the integrity of a one of the at least one primary article via the computing device: the computing device accessing the retraction table of the associated article record for said primary article; upon the computing device determining that said primary article has been retracted, the computing device adding a pre-defined numerical primary article weight to the article score for said primary article; the computing device determining a primary source total count representing a quantity of primary sources associated with said primary article; the computing device determining a primary source retraction count representing a quantity of said primary sources associated with said primary article that have been retracted; the computing device generating a primary source ratio by calculating a quotient of the primary source retraction count divided by the primary source total count; the computing device multiplying the primary source ratio by a pre-defined numerical primary source weight that is relatively less than the primary article weight, and adding the product of said calculation to the article score; the computing device determining a secondary source total count representing a quantity of secondary sources associated with said primary article; the computing device determining a secondary source retraction count representing a quantity of said secondary sources associated with said primary article that have been retracted; the computing device generating a secondary source ratio by calculating a quotient of the secondary source retraction count divided by the secondary source total count; the computing device multiplying the secondary source ratio by a pre-defined numerical secondary source weight that is relatively less than the primary source weight, and adding the product of said calculation to the article score; the computing device determining a tertiary source total count representing a quantity of tertiary sources associated with said primary article; the computing device determining a tertiary source retraction count representing a quantity of said tertiary sources associated with said primary article that have been retracted; the computing device generating a tertiary source ratio by calculating a quotient of the tertiary source retraction count divided by the tertiary source total count; and the computing device multiplying the tertiary source ratio by a pre-defined numerical tertiary source weight that is relatively less than the secondary source weight, and adding the product of said calculation to the article score; whereby, the article score represents a standardized, relative and absolute score denoting quality and reliability of said primary article, such that the lower the article score, the relatively more reliable said primary article is determined to be.

2. The method according to embodiment 1, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

3. The method according to embodiments 1-2, further comprising the steps of: upon the computing device determining that said primary article has been published in a publication identified as being predatory, the computing device increasing the article score for said primary article by a pre-defined numerical primary article predatory value; for any primary source associated with said primary article, upon the computing device determining that said primary source has been published in a publication identified as being predatory, the computing device increasing the article score for said primary article by a pre-defined numerical primary source predatory value that is relatively less than the primary article predatory value; for any secondary source associated with said primary article, upon the computing device determining that said secondary source has been published in a publication identified as being predatory, the computing device increasing the article score for said primary article by a pre-defined numerical secondary source predatory value that is relatively less than the primary source predatory value; and for any tertiary source associated with said primary article, upon the computing device determining that said tertiary source has been published in a publication identified as being predatory, the computing device increasing the article score for said primary article by a pre-defined numerical tertiary source predatory value that is relatively less than the secondary source predatory value.

4. The method according to embodiments 1-3, further comprising the steps of: upon the computing device determining that an at least one author associated with said primary article has engaged in self-citing that exceeds a pre-defined threshold quantity, the computing device increasing the article score for said primary article by a pre-defined numerical primary article self-citing value; for any primary source associated with said primary article, upon the computing device determining that an at least one author associated with said primary source has engaged in self-citing that exceeds the pre-defined threshold quantity, the computing device increasing the article score for said primary article by a pre-defined numerical primary source self-citing value that is relatively less than the primary article self-citing value; for any secondary source associated with said primary article, upon the computing device determining that an at least one author associated with said secondary source has engaged in self-citing that exceeds the pre-defined threshold quantity, the computing device increasing the article score for said primary article by a pre-defined numerical secondary source self-citing value that is relatively less than the primary source self-citing value; and for any tertiary source associated with said primary article, upon the computing device determining that an at least one author associated with said tertiary source has engaged in self-citing that exceeds the pre-defined threshold quantity, the computing device increasing the article score for said primary article by a pre-defined numerical tertiary source self-citing value that is relatively less than the secondary source self-citing value.

5. The method according to embodiments 1-4, further comprising the steps of: upon the computing device determining that said primary article has been published in a publication identified as failing to issue retractions, the computing device increasing the article score for said primary article by a pre-defined numerical primary article retraction value; for any primary source associated with said primary article, upon the computing device determining that said primary source has been published in a publication identified as failing to issue retractions, the computing device increasing the article score for said primary article by a pre-defined numerical primary source retraction value that is relatively less than the primary article retraction value; for any secondary source associated with said primary article, upon the computing device determining that said secondary source has been published in a publication identified as failing to issue retractions, the computing device increasing the article score for said primary article by a pre-defined numerical secondary source retraction value that is relatively less than the primary source retraction value; and for any tertiary source associated with said primary article, upon the computing device determining that said tertiary source has been published in a publication identified as failing to issue retractions, the computing device increasing the article score for said primary article by a pre-defined numerical tertiary source retraction value that is relatively less than the secondary source retraction value.

6. The method according to embodiments 1-5, further comprising the step of the computing device ranking each of the at least one primary article based on the associated article score.

7. A source validation system configured for automatically monitoring and validating the integrity of an at least one primary article on behalf of a user, the system comprising: a computing device configured for receiving and processing data related to the at least one primary article and at least one of an at least one associated primary source, secondary source and tertiary source; an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and upon the user desiring to validate the integrity of a one of the at least one primary article via the computing device, the computing device is configured for: accessing the retraction table of the associated article record for said primary article; upon the computing device determining that said primary article has been retracted, adding a pre-defined numerical primary article weight to the article score for said primary article; determining a primary source total count representing a quantity of primary sources associated with said primary article; determining a primary source retraction count representing a quantity of said primary sources associated with said primary article that have been retracted; generating a primary source ratio by calculating a quotient of the primary source retraction count divided by the primary source total count; multiplying the primary source ratio by a pre-defined numerical primary source weight that is relatively less than the primary article weight, and adding the product of said calculation to the article score; determining a secondary source total count representing a quantity of secondary sources associated with said primary article; determining a secondary source retraction count representing a quantity of said secondary sources associated with said primary article that have been retracted; generating a secondary source ratio by calculating a quotient of the secondary source retraction count divided by the secondary source total count; multiplying the secondary source ratio by a pre-defined numerical secondary source weight that is relatively less than the primary source weight, and adding the product of said calculation to the article score; determining a tertiary source total count representing a quantity of tertiary sources associated with said primary article; determining a tertiary source retraction count representing a quantity of said tertiary sources associated with said primary article that have been retracted; generating a tertiary source ratio by calculating a quotient of the tertiary source retraction count divided by the tertiary source total count; and multiplying the tertiary source ratio by a pre-defined numerical tertiary source weight that is relatively less than the secondary source weight, and adding the product of said calculation to the article score; whereby, the article score represents a standardized, relative and absolute score denoting quality and reliability of said primary article, such that the lower the article score, the relatively more reliable said primary article is determined to be.

8. The source validation system according to embodiment 7, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

9. The source validation system according to embodiments 7-8, wherein the computing device is further configured for: upon the computing device determining that said primary article has been published in a publication identified as being predatory, increasing the article score for said primary article by a pre-defined numerical primary article predatory value; for any primary source associated with said primary article, upon the computing device determining that said primary source has been published in a publication identified as being predatory, increasing the article score for said primary article by a pre-defined numerical primary source predatory value that is relatively less than the primary article predatory value; for any secondary source associated with said primary article, upon the computing device determining that said secondary source has been published in a publication identified as being predatory, increasing the article score for said primary article by a pre-defined numerical secondary source predatory value that is relatively less than the primary source predatory value; and for any tertiary source associated with said primary article, upon the computing device determining that said tertiary source has been published in a publication identified as being predatory, increasing the article score for said primary article by a pre-defined numerical tertiary source predatory value that is relatively less than the secondary source predatory value.

10. The source validation system according to embodiments 7-9, wherein the computing device is further configured for: upon the computing device determining that an at least one author associated with said primary article has engaged in self-citing that exceeds a pre-defined threshold quantity, increasing the article score for said primary article by a pre-defined numerical primary article self-citing value; for any primary source associated with said primary article, upon the computing device determining that an at least one author associated with said primary source has engaged in self-citing that exceeds the pre-defined threshold quantity, increasing the article score for said primary article by a pre-defined numerical primary source self-citing value that is relatively less than the primary article self-citing value; for any secondary source associated with said primary article, upon the computing device determining that an at least one author associated with said secondary source has engaged in self-citing that exceeds the pre-defined threshold quantity, increasing the article score for said primary article by a pre-defined numerical secondary source self-citing value that is relatively less than the primary source self-citing value; and for any tertiary source associated with said primary article, upon the computing device determining that an at least one author associated with said tertiary source has engaged in self-citing that exceeds the pre-defined threshold quantity, increasing the article score for said primary article by a pre-defined numerical tertiary source self-citing value that is relatively less than the secondary source self-citing value.

11. The source validation system according to embodiments 7-10, wherein the computing device is further configured for: upon the computing device determining that said primary article has been published in a publication identified as failing to issue retractions, increasing the article score for said primary article by a pre-defined numerical primary article retraction value; for any primary source associated with said primary article, upon the computing device determining that said primary source has been published in a publication identified as failing to issue retractions, increasing the article score for said primary article by a pre-defined numerical primary source retraction value that is relatively less than the primary article retraction value; for any secondary source associated with said primary article, upon the computing device determining that said secondary source has been published in a publication identified as failing to issue retractions, increasing the article score for said primary article by a pre-defined numerical secondary source retraction value that is relatively less than the primary source retraction value; and for any tertiary source associated with said primary article, upon the computing device determining that said tertiary source has been published in a publication identified as failing to issue retractions, increasing the article score for said primary article by a pre-defined numerical tertiary source retraction value that is relatively less than the secondary source retraction value.

12. The source validation system according to embodiments 7-11, wherein the computing device is further configured for ranking each of the at least one primary article based on the associated article score.

13. The source validation system according to embodiments 7-12, further comprising an at least one database in communication with the computing device and configured for selectively storing said data related to an at least one primary article and at least one of an at least one associated primary source, secondary source and tertiary source.

14. The source validation system according to embodiments 7-13, wherein the computing device is in selective communication with an at least one third-party retraction database containing retraction-related data in connection with at least one of the at least one primary article, primary source, secondary source and tertiary source.

15. A non-transitory computer readable medium containing program instructions for causing an at least one computing device to perform a method of monitoring and validating the integrity of an at least one primary article on behalf of a user, the computing device configured for receiving and processing data related to the at least one primary article and at least one of an at least one associated primary source, secondary source and tertiary source, the method comprising the steps of: establishing an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and upon the user desiring to validate the integrity of a one of the at least one primary article via the computing device: accessing the retraction table of the associated article record for said primary article; upon determining that said primary article has been retracted, adding a pre-defined numerical primary article weight to the article score for said primary article; determining a primary source total count representing a quantity of primary sources associated with said primary article; determining a primary source retraction count representing a quantity of said primary sources associated with said primary article that have been retracted; generating a primary source ratio by calculating a quotient of the primary source retraction count divided by the primary source total count; multiplying the primary source ratio by a pre-defined numerical primary source weight that is relatively less than the primary article weight, and adding the product of said calculation to the article score; determining a secondary source total count representing a quantity of secondary sources associated with said primary article; determining a secondary source retraction count representing a quantity of said secondary sources associated with said primary article that have been retracted; generating a secondary source ratio by calculating a quotient of the secondary source retraction count divided by the secondary source total count; multiplying the secondary source ratio by a pre-defined numerical secondary source weight that is relatively less than the primary source weight, and adding the product of said calculation to the article score; determining a tertiary source total count representing a quantity of tertiary sources associated with said primary article; determining a tertiary source retraction count representing a quantity of said tertiary sources associated with said primary article that have been retracted; generating a tertiary source ratio by calculating a quotient of the tertiary source retraction count divided by the tertiary source total count; and multiplying the tertiary source ratio by a pre-defined numerical tertiary source weight that is relatively less than the secondary source weight, and adding the product of said calculation to the article score; whereby, the article score represents a standardized, relative and absolute score denoting quality and reliability of said primary article, such that the lower the article score, the relatively more reliable said primary article is determined to be.

16. The method according to embodiment 15, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

17. The method according to embodiments 15-16, further comprising the steps of: upon determining that said primary article has been published in a publication identified as being predatory, increasing the article score for said primary article by a pre-defined numerical primary article predatory value; for any primary source associated with said primary article, upon determining that said primary source has been published in a publication identified as being predatory, increasing the article score for said primary article by a pre-defined numerical primary source predatory value that is relatively less than the primary article predatory value; for any secondary source associated with said primary article, upon determining that said secondary source has been published in a publication identified as being predatory, increasing the article score for said primary article by a pre-defined numerical secondary source predatory value that is relatively less than the primary source predatory value; and for any tertiary source associated with said primary article, upon determining that said tertiary source has been published in a publication identified as being predatory, increasing the article score for said primary article by a pre-defined numerical tertiary source predatory value that is relatively less than the secondary source predatory value.

18. The method according to embodiments 15-17, further comprising the steps of: upon determining that an at least one author associated with said primary article has engaged in self-citing that exceeds a pre-defined threshold quantity, increasing the article score for said primary article by a pre-defined numerical primary article self-citing value; for any primary source associated with said primary article, upon determining that an at least one author associated with said primary source has engaged in self-citing that exceeds the pre-defined threshold quantity, increasing the article score for said primary article by a pre-defined numerical primary source self-citing value that is relatively less than the primary article self-citing value; for any secondary source associated with said primary article, upon determining that an at least one author associated with said secondary source has engaged in self-citing that exceeds the pre-defined threshold quantity, increasing the article score for said primary article by a pre-defined numerical secondary source self-citing value that is relatively less than the primary source self-citing value; and for any tertiary source associated with said primary article, upon determining that an at least one author associated with said tertiary source has engaged in self-citing that exceeds the pre-defined threshold quantity, increasing the article score for said primary article by a pre-defined numerical tertiary source self-citing value that is relatively less than the secondary source self-citing value.

19. The method according to embodiments 15-18, further comprising the steps of: upon determining that said primary article has been published in a publication identified as failing to issue retractions, increasing the article score for said primary article by a pre-defined numerical primary article retraction value; for any primary source associated with said primary article, upon determining that said primary source has been published in a publication identified as failing to issue retractions, increasing the article score for said primary article by a pre-defined numerical primary source retraction value that is relatively less than the primary article retraction value; for any secondary source associated with said primary article, upon determining that said secondary source has been published in a publication identified as failing to issue retractions, increasing the article score for said primary article by a pre-defined numerical secondary source retraction value that is relatively less than the primary source retraction value; and for any tertiary source associated with said primary article, upon determining that said tertiary source has been published in a publication identified as failing to issue retractions, increasing the article score for said primary article by a pre-defined numerical tertiary source retraction value that is relatively less than the secondary source retraction value.

20. The method according to embodiments 15-19, further comprising the step of ranking each of the at least one primary article based on the associated article score.

In closing, regarding the exemplary embodiments of the present invention as shown and described herein, it will be appreciated that a source validation system is disclosed and configured for automatically monitoring and validating the integrity of scientific research sources. Because the principles of the invention may be practiced in a number of configurations beyond those shown and described, it is to be understood that the invention is not in any way limited by the exemplary embodiments, but is generally directed to a source validation system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators - such as “first,” “second,” “third,” etc. - for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. §112(f) will begin with the words “means for,” but use of the term “for” in any other context is not intended to invoke treatment under 35 U.S.C. §112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The phrase “non-transitory,” in addition to having its ordinary meaning, as used in this document means “enduring or long-lived”. The phrase “non-transitory computer readable medium,” in addition to having its ordinary meaning, includes any and all computer readable mediums, with the sole exception of a transitory, propagating signal. This includes, by way of example and not limitation, non-transitory computer-readable mediums such as register memory, processor cache and random-access memory (“RAM”).

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicant and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for monitoring and validating the integrity of an at least one primary article on behalf of a user, the method comprising the steps of:
implementing a computing device configured for receiving and processing data related to the at least one primary article and at least one of an at least one associated primary source, secondary source and tertiary source;
establishing, via the computing device, an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and
upon the user desiring to validate the integrity of a one of the at least one primary article via the computing device:
the computing device accessing the retraction table of the associated article record for said primary article;
upon the computing device determining that said primary article has been retracted, the computing device adding a pre-defined numerical primary article weight to the article score for said primary article;
the computing device determining a primary source total count representing a quantity of primary sources associated with said primary article;
the computing device determining a primary source retraction count representing a quantity of said primary sources associated with said primary article that have been retracted;
the computing device generating a primary source ratio by calculating a quotient of the primary source retraction count divided by the primary source total count;
the computing device multiplying the primary source ratio by a pre-defined numerical primary source weight that is relatively less than the primary article weight, and adding the product of said calculation to the article score;
the computing device determining a secondary source total count representing a quantity of secondary sources associated with said primary article;
the computing device determining a secondary source retraction count representing a quantity of said secondary sources associated with said primary article that have been retracted;
the computing device generating a secondary source ratio by calculating a quotient of the secondary source retraction count divided by the secondary source total count;
the computing device multiplying the secondary source ratio by a pre-defined numerical secondary source weight that is relatively less than the primary source weight, and adding the product of said calculation to the article score;
the computing device determining a tertiary source total count representing a quantity of tertiary sources associated with said primary article;
the computing device determining a tertiary source retraction count representing a quantity of said tertiary sources associated with said primary article that have been retracted;
the computing device generating a tertiary source ratio by calculating a quotient of the tertiary source retraction count divided by the tertiary source total count; and
the computing device multiplying the tertiary source ratio by a pre-defined numerical tertiary source weight that is relatively less than the secondary source weight, and adding the product of said calculation to the article score;
whereby, the article score represents a standardized, relative and absolute score denoting quality and reliability of said primary article, such that the lower the article score, the relatively more reliable said primary article is determined to be.

2. The method of claim 1, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

3. The method of claim 1, further comprising the steps of:
upon the computing device determining that said primary article has been published in a publication identified as being predatory, the computing device increasing the article score for said primary article by a pre-defined numerical primary article predatory value;
for any primary source associated with said primary article, upon the computing device determining that said primary source has been published in a publication identified as being predatory, the computing device increasing the article score for said primary article by a pre-defined numerical primary source predatory value that is relatively less than the primary article predatory value;
for any secondary source associated with said primary article, upon the computing device determining that said secondary source has been published in a publication identified as being predatory, the computing device increasing the article score for said primary article by a pre-defined numerical secondary source predatory value that is relatively less than the primary source predatory value; and
for any tertiary source associated with said primary article, upon the computing device determining that said tertiary source has been published in a publication identified as being predatory, the computing device increasing the article score for said primary article by a pre-defined numerical tertiary source predatory value that is relatively less than the secondary source predatory value.

4. The method of claim 1, further comprising the steps of:
upon the computing device determining that an at least one author associated with said primary article has engaged in self-citing that exceeds a pre-defined threshold quantity, the computing device increasing the article score for said primary article by a pre-defined numerical primary article self-citing value;
for any primary source associated with said primary article, upon the computing device determining that an at least one author associated with said primary source has engaged in self-citing that exceeds the pre-defined threshold quantity, the computing device increasing the article score for said primary article by a pre-defined numerical primary source self-citing value that is relatively less than the primary article self-citing value;
for any secondary source associated with said primary article, upon the computing device determining that an at least one author associated with said secondary source has engaged in self-citing that exceeds the pre-defined threshold quantity, the computing device increasing the article score for said primary article by a pre-defined numerical secondary source self-citing value that is relatively less than the primary source self-citing value; and
for any tertiary source associated with said primary article, upon the computing device determining that an at least one author associated with said tertiary source has engaged in self-citing that exceeds the pre-defined threshold quantity, the computing device increasing the article score for said primary article by a pre-defined numerical tertiary source self-citing value that is relatively less than the secondary source self-citing value.

5. The method of claim 1, further comprising the steps of:
upon the computing device determining that said primary article has been published in a publication identified as failing to issue retractions, the computing device increasing the article score for said primary article by a pre-defined numerical primary article retraction value;
for any primary source associated with said primary article, upon the computing device determining that said primary source has been published in a publication identified as failing to issue retractions, the computing device increasing the article score for said primary article by a pre-defined numerical primary source retraction value that is relatively less than the primary article retraction value;
for any secondary source associated with said primary article, upon the computing device determining that said secondary source has been published in a publication identified as failing to issue retractions, the computing device increasing the article score for said primary article by a pre-defined numerical secondary source retraction value that is relatively less than the primary source retraction value; and
for any tertiary source associated with said primary article, upon the computing device determining that said tertiary source has been published in a publication identified as failing to issue retractions, the computing device increasing the article score for said primary article by a pre-defined numerical tertiary source retraction value that is relatively less than the secondary source retraction value.

6. The method of claim 1, further comprising the step of the computing device ranking each of the at least one primary article based on the associated article score.

7. A source validation system configured for automatically monitoring and validating the integrity of an at least one primary article on behalf of a user, the system comprising:
a computing device configured for receiving and processing data related to the at least one primary article and at least one of an at least one associated primary source, secondary source and tertiary source;
an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and
upon the user desiring to validate the integrity of a one of the at least one primary article via the computing device, the computing device is configured for:
accessing the retraction table of the associated article record for said primary article;
upon the computing device determining that said primary article has been retracted, adding a pre-defined numerical primary article weight to the article score for said primary article;
determining a primary source total count representing a quantity of primary sources associated with said primary article;
determining a primary source retraction count representing a quantity of said primary sources associated with said primary article that have been retracted;
generating a primary source ratio by calculating a quotient of the primary source retraction count divided by the primary source total count;
multiplying the primary source ratio by a pre-defined numerical primary source weight that is relatively less than the primary article weight, and adding the product of said calculation to the article score;
determining a secondary source total count representing a quantity of secondary sources associated with said primary article;
determining a secondary source retraction count representing a quantity of said secondary sources associated with said primary article that have been retracted;
generating a secondary source ratio by calculating a quotient of the secondary source retraction count divided by the secondary source total count;
multiplying the secondary source ratio by a pre-defined numerical secondary source weight that is relatively less than the primary source weight, and adding the product of said calculation to the article score;
determining a tertiary source total count representing a quantity of tertiary sources associated with said primary article;
determining a tertiary source retraction count representing a quantity of said tertiary sources associated with said primary article that have been retracted;
generating a tertiary source ratio by calculating a quotient of the tertiary source retraction count divided by the tertiary source total count; and
multiplying the tertiary source ratio by a pre-defined numerical tertiary source weight that is relatively less than the secondary source weight, and adding the product of said calculation to the article score;
whereby, the article score represents a standardized, relative and absolute score denoting quality and reliability of said primary article, such that the lower the article score, the relatively more reliable said primary article is determined to be.

8. The source validation system of claim 7, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

9. The source validation system of claim 7, wherein the computing device is further configured for:
upon the computing device determining that said primary article has been published in a publication identified as being predatory, increasing the article score for said primary article by a pre-defined numerical primary article predatory value;
for any primary source associated with said primary article, upon the computing device determining that said primary source has been published in a publication identified as being predatory, increasing the article score for said primary article by a pre-defined numerical primary source predatory value that is relatively less than the primary article predatory value;
for any secondary source associated with said primary article, upon the computing device determining that said secondary source has been published in a publication identified as being predatory, increasing the article score for said primary article by a pre-defined numerical secondary source predatory value that is relatively less than the primary source predatory value; and
for any tertiary source associated with said primary article, upon the computing device determining that said tertiary source has been published in a publication identified as being predatory, increasing the article score for said primary article by a pre-defined numerical tertiary source predatory value that is relatively less than the secondary source predatory value.

10. The source validation system of claim 7, wherein the computing device is further configured for:
upon the computing device determining that an at least one author associated with said primary article has engaged in self-citing that exceeds a pre-defined threshold quantity, increasing the article score for said primary article by a pre-defined numerical primary article self-citing value;
for any primary source associated with said primary article, upon the computing device determining that an at least one author associated with said primary source has engaged in self-citing that exceeds the pre-defined threshold quantity, increasing the article score for said primary article by a pre-defined numerical primary source self-citing value that is relatively less than the primary article self-citing value;
for any secondary source associated with said primary article, upon the computing device determining that an at least one author associated with said secondary source has engaged in self-citing that exceeds the pre-defined threshold quantity, increasing the article score for said primary article by a pre-defined numerical secondary source self-citing value that is relatively less than the primary source self-citing value; and
for any tertiary source associated with said primary article, upon the computing device determining that an at least one author associated with said tertiary source has engaged in self-citing that exceeds the pre-defined threshold quantity, increasing the article score for said primary article by a pre-defined numerical tertiary source self-citing value that is relatively less than the secondary source self-citing value.

11. The source validation system of claim 7, wherein the computing device is further configured for:
upon the computing device determining that said primary article has been published in a publication identified as failing to issue retractions, increasing the article score for said primary article by a pre-defined numerical primary article retraction value;
for any primary source associated with said primary article, upon the computing device determining that said primary source has been published in a publication identified as failing to issue retractions, increasing the article score for said primary article by a pre-defined numerical primary source retraction value that is relatively less than the primary article retraction value;
for any secondary source associated with said primary article, upon the computing device determining that said secondary source has been published in a publication identified as failing to issue retractions, increasing the article score for said primary article by a pre-defined numerical secondary source retraction value that is relatively less than the primary source retraction value; and
for any tertiary source associated with said primary article, upon the computing device determining that said tertiary source has been published in a publication identified as failing to issue retractions, increasing the article score for said primary article by a pre-defined numerical tertiary source retraction value that is relatively less than the secondary source retraction value.

12. The source validation system of claim 7, wherein the computing device is further configured for ranking each of the at least one primary article based on the associated article score.

13. The source validation system of claim 7, further comprising an at least one database in communication with the computing device and configured for selectively storing said data related to an at least one primary article and at least one of an at least one associated primary source, secondary source and tertiary source.

14. The source validation system of claim 7, wherein the computing device is in selective communication with an at least one third-party retraction database containing retraction-related data in connection with at least one of the at least one primary article, primary source, secondary source and tertiary source.

15. A non-transitory computer readable medium containing program instructions for causing an at least one computing device to perform a method of monitoring and validating the integrity of an at least one primary article on behalf of a user, the computing device configured for receiving and processing data related to the at least one primary article and at least one of an at least one associated primary source, secondary source and tertiary source, the method comprising the steps of:
establishing an at least one article record associated with each of the at least one primary article, each of the at least one article record containing at least one of a unique record identifier, a source table containing details related to each of the at least one primary source, secondary source and tertiary source associated with the corresponding primary article, a retraction table containing details related to any instances in which the corresponding primary article has been retracted, and an article score containing a numerical value corresponding to a relative validity of the corresponding primary article; and
upon the user desiring to validate the integrity of a one of the at least one primary article via the computing device:
accessing the retraction table of the associated article record for said primary article;
upon determining that said primary article has been retracted, adding a pre-defined numerical primary article weight to the article score for said primary article;
determining a primary source total count representing a quantity of primary sources associated with said primary article;
determining a primary source retraction count representing a quantity of said primary sources associated with said primary article that have been retracted;
generating a primary source ratio by calculating a quotient of the primary source retraction count divided by the primary source total count;
multiplying the primary source ratio by a pre-defined numerical primary source weight that is relatively less than the primary article weight, and adding the product of said calculation to the article score;
determining a secondary source total count representing a quantity of secondary sources associated with said primary article;
determining a secondary source retraction count representing a quantity of said secondary sources associated with said primary article that have been retracted;
generating a secondary source ratio by calculating a quotient of the secondary source retraction count divided by the secondary source total count;
multiplying the secondary source ratio by a pre-defined numerical secondary source weight that is relatively less than the primary source weight, and adding the product of said calculation to the article score;
determining a tertiary source total count representing a quantity of tertiary sources associated with said primary article;
determining a tertiary source retraction count representing a quantity of said tertiary sources associated with said primary article that have been retracted;
generating a tertiary source ratio by calculating a quotient of the tertiary source retraction count divided by the tertiary source total count; and
multiplying the tertiary source ratio by a pre-defined numerical tertiary source weight that is relatively less than the secondary source weight, and adding the product of said calculation to the article score;
whereby, the article score represents a standardized, relative and absolute score denoting quality and reliability of said primary article, such that the lower the article score, the relatively more reliable said primary article is determined to be.

16. The method of claim 15, wherein the each of the at least one article record further contains at least one of an article title associated with the corresponding primary article, an abstract associated with the corresponding primary article, an at least one author associated with the corresponding primary article, a publication name in which the corresponding primary article was published, and additional publication details associated with the corresponding primary article.

17. The method of claim 15, further comprising the steps of:
upon determining that said primary article has been published in a publication identified as being predatory, increasing the article score for said primary article by a pre-defined numerical primary article predatory value;
for any primary source associated with said primary article, upon determining that said primary source has been published in a publication identified as being predatory, increasing the article score for said primary article by a pre-defined numerical primary source predatory value that is relatively less than the primary article predatory value;
for any secondary source associated with said primary article, upon determining that said secondary source has been published in a publication identified as being predatory, increasing the article score for said primary article by a pre-defined numerical secondary source predatory value that is relatively less than the primary source predatory value; and
for any tertiary source associated with said primary article, upon determining that said tertiary source has been published in a publication identified as being predatory, increasing the article score for said primary article by a pre-defined numerical tertiary source predatory value that is relatively less than the secondary source predatory value.

18. The method of claim 15, further comprising the steps of:
upon determining that an at least one author associated with said primary article has engaged in self-citing that exceeds a pre-defined threshold quantity, increasing the article score for said primary article by a pre-defined numerical primary article self-citing value;
for any primary source associated with said primary article, upon determining that an at least one author associated with said primary source has engaged in self-citing that exceeds the pre-defined threshold quantity, increasing the article score for said primary article by a pre-defined numerical primary source self-citing value that is relatively less than the primary article self-citing value;
for any secondary source associated with said primary article, upon determining that an at least one author associated with said secondary source has engaged in self-citing that exceeds the pre-defined threshold quantity, increasing the article score for said primary article by a pre-defined numerical secondary source self-citing value that is relatively less than the primary source self-citing value; and
for any tertiary source associated with said primary article, upon determining that an at least one author associated with said tertiary source has engaged in self-citing that exceeds the pre-defined threshold quantity, increasing the article score for said primary article by a pre-defined numerical tertiary source self-citing value that is relatively less than the secondary source self-citing value.

19. The method of claim 15, further comprising the steps of:
upon determining that said primary article has been published in a publication identified as failing to issue retractions, increasing the article score for said primary article by a pre-defined numerical primary article retraction value;
for any primary source associated with said primary article, upon determining that said primary source has been published in a publication identified as failing to issue retractions, increasing the article score for said primary article by a pre-defined numerical primary source retraction value that is relatively less than the primary article retraction value;
for any secondary source associated with said primary article, upon determining that said secondary source has been published in a publication identified as failing to issue retractions, increasing the article score for said primary article by a pre-defined numerical secondary source retraction value that is relatively less than the primary source retraction value; and
for any tertiary source associated with said primary article, upon determining that said tertiary source has been published in a publication identified as failing to issue retractions, increasing the article score for said primary article by a pre-defined numerical tertiary source retraction value that is relatively less than the secondary source retraction value.

20. The method of claim 15, further comprising the step of ranking each of the at least one primary article based on the associated article score.
